(19) United States
(12) Patent Application Publication
(10) Pub. No.: US 2018/0356279 A1
(43) Pub. Date: Dec. 13, 2018

(54) i1-Scale; enhancements through continutations in parts

(71) Applicant: Mark Belloni, Brewster, OH (US)

(72) Inventor: Mark Belloni, Brewster, OH (US)

(21) Appl. No.: 15/731,442

(22) Filed: Jun. 10, 2017

(51) Int. Cl. G01G 19/02

(52) U.S. Cl. CPC G01G 19/027; G08B 29/046

(57) ABSTRACT

Electromagnetic sensors which will enhance the recorded axle weight measurement data of a portable smart scale are: an incline meter and a laser distance measuring device. These sensors are added to the claims of the previous patent pending with filing No.: 14/806584. The incline meter will aid in accounting for weight measurements made on a flat surface which is inclined. Due to the limited displacement brought about by the linearity requirement enforced on sensor system material; an accurate displacement measuring device will enhance small relative motion detection.

### BACKGROUND OF INVENTION

This is a continuation In Part of the i1-Scale 14/806584; as, the content of the claims herein are considered new matter to the original i1-Scale patent application.

Objects with mass which are in the presence of a gravitational field will experience a force. The product of the magnitude of the gravity field and the mass of the object determine the magnitude of the force or pull that the object experiences. If the object is unsupported, the force will displace the object indefinitely due to Newton's 2^{nd} Law.

Suppose that the massive object comes in contact with a support which is grounded. Then by Newton's 3^{rd} Law, a reactive force equal in magnitude and opposite in direction of the gravitational field will accumulate at the contact interface and is commonly referred to as weight. Real objects in contact with one another have a definite interface area which the force acts over and it is said that the ratio between this force and interface area is called traction. The traction is commonly referred to as a pressure patch.

Suppose that the weight acts perpendicular to a flat interface surface which it contacts with; then the reactive force is purely in the direction normal to the gravitational force. Suppose further that the weight does not act exactly normal to the flat contact surface; then, a component of the weight generally opposed by friction—will be tangent to the flat surface while another component will be normal to the surface such that the vector addition of these 2 weight components is the true weight of the massive object.

For the purpose of the i1-Scale it is assumed that the surface of the platform 0014 (see patent application id above) will be flat and not necessarily be oriented parallel to the truck axle which the wheel and tires are mounted to. Hence the need to know the inclination of the platform along two perpendicular directions; namely along the forward and aft direction and the port to starboard direction. The incline meter 001 is capable of determining these inclines electronically.

The incline data is collected before the truck is weighed. It is then used to back calculate the true weight of the axle using vector addition that the controller 022, 0014 (see patent application id above) performs.

Another Continuation In Part to the i1-Scale, considered new matter, is the electronic sensor for measuring displacement 004 of the sensing system. Due to the linear requirement placed on the material; a small displacement field results of which a laser is capable of detecting. Attaching the laser to the sensing system will enable the sensor to detect small displacement data, electronically. This electronic data will be conditioned and transmitted to the controller.

Moreover, it is noted that the there is a need for tamper proof electronic and mechanical mechanisms for the system of which these devices will support. The tamper proofing of the system is not limited to current technology. Tamper proofing can be encryption, unbroken or broken adhesive seals 002 and 003, and those of ordinary skill in the art.

All sensors 001, 002, 004, and 012 (see patent application id above for these 4 listed) and signal conditioner electronics 023 (see patent application id above) associated with the measuring of axle weight can be wire and or wireless devices. All sensors 001, 002, and 004 in continuation in parts.

In the spirit of the i1-Scale invention, the detachable sensor element and sensor contents 004 and 012, (see patent application id above) sensors only and signal conditioner 023 (see patent application id above) may be retro fit onto a trailer, tractor, or tractor trailer eliminating the need for the light weight frame detailed in FIG. 11 of the i1-Scale patent application Ser. No. 14/806584.

In the spirit of the it-Scale invention, the detachable sensor element and sensor contents 004 and 012, (see patent application id above) sensors only and signal conditioner 023 (see patent application id above) may be constructed into a trailer, tractor, or tractor trailer at the factory eliminating the need for the light weight frame detailed in FIG. 11 of the i1-Scale patent application Ser. No. 14/806584.

As an example, consider a carbon fiber epoxy matrix composite construction of a thin plate which has strain gages embedded between lamina of the plate. The strain gages may be wire or wireless. This smart plate may be adhered to the load carrying member of a tractor and trailer using high strength adhesives such that one surface of the laminate is bonded to the surface of the member forming a bonded interface. The signal conditioner can be mounted substantially in close proximity of the bonded laminate such that the signal conditioner receive and transmit electronic signals. This arrangement can be used to measure and store strain when the trailer is unloaded and then again when the trailer is loaded providing a change in strain data which can be used to directly calculate the unknown axle loads.

### BRIEF DESCRIPTION OF THE DRAWINGS

FIG. 1 is a picture of an electronic incline meter 001 which is capable of detecting orientations of planes which are not in planes are not parallel to a reference plane. This device will aid in the determination of the true axle weight of a vehicle.

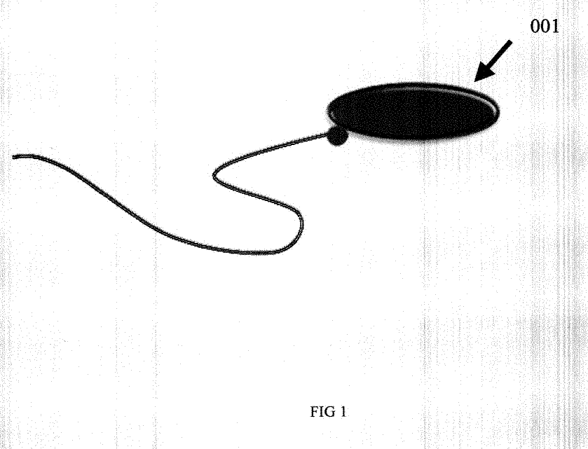

FIG. 2 shows a conductive thin lamina 002, and circuit, which is compact and able to complete an electric circuit.

FIG. 3 shows a torn conductive thin lamina 003, and circuit, which is compact and unable to complete an electric circuit.

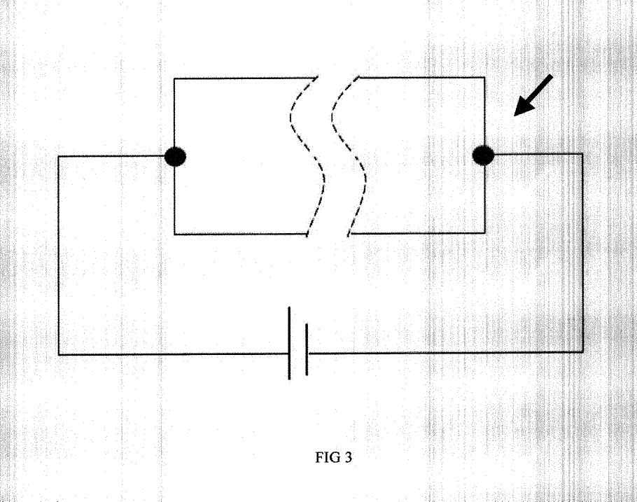

FIG. 4 shows a thin lamina 004 which is compact and able to identify a tractor trailer similar to a license registration sticker for an automobile. This thin lamina 004 contains an electronic identification which is unique to each scale device and is attached to the under carriage of the corresponding tractor such that the i1-scale may read and process the id tag.

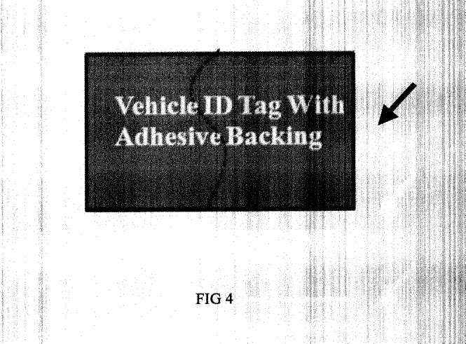

FIG. 5 is a sketch of a displacement sensor 005. The dotted line indicates that the sensor can have a wire or can be wireless.

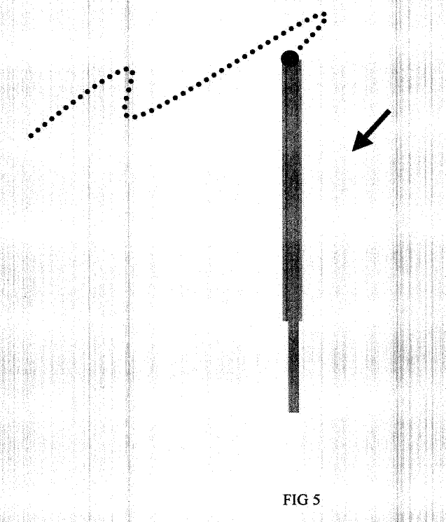

FIG. 6 is a sketch of a fiber epoxy lamina with arbitrary fiber orientation, where a strain gage is typically embedded between the mid plane lamina, and the laminate after manufacturing.

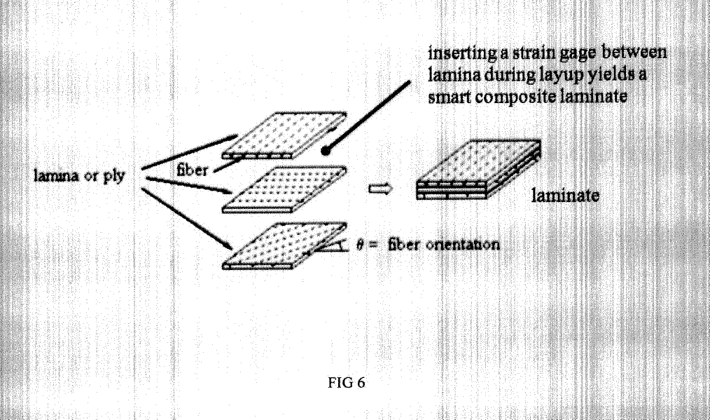

FIG. 7 is a sketch of a top view of the laminate composite plate 006 and embedded strain gage 007 with dotted lines indicating the lead wires. The gage can be wireless.

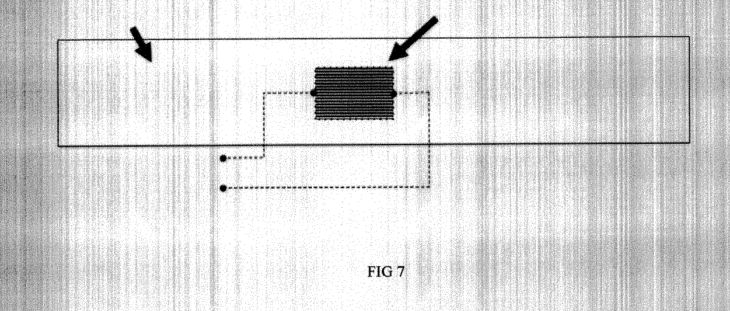

FIG. 8 is a sketch of a side view of the thin laminate composite plate 006 and embedded strain gage 007 with dotted lines indicating the lead wires. The gage can be wireless.

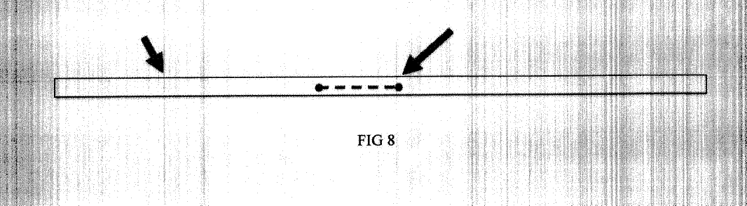

FIG. 9 is a sketch of an end view of the laminate composite plate 006 and embedded strain gage 007 with dotted lines indicating the lead wires. The gage can be wireless.

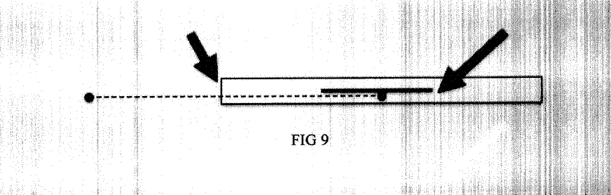

FIG. 10 is a sketch of the laminate composite plate 006 and embedded strain gage 007 bonded to the load carrying member 009 of a tractor or trailer. The gage can be wired or wireless.

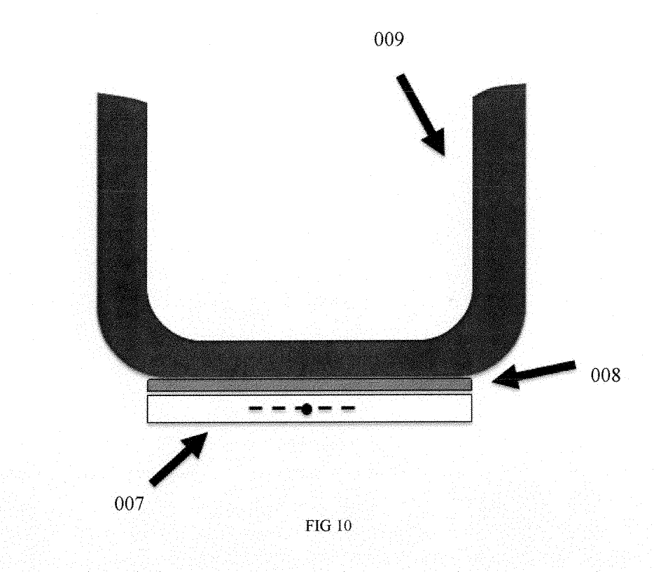

### DESCRIPTION OF DRAWING REFERENCE NUMBERS

001 Incline meter; wired or wireless

002 Thin conductive material with closed circuit: un-tampered circuit

003 Thin conductive material with open circuit: tampered circuit

004 Vehicle tracking ID tag

005 Extensometer; wire or wireless

006 Thin laminate plate

007 Embedded strain gage wired or wireless

008 High strength adhesive layer bonding laminate to load carrying member

009 Load carrying member; portion of section view

1. In the spirit of i1-Scale patent application Ser. No. 14/806584, claim [0009], the modular hollow detachable housing will include a incline meter.

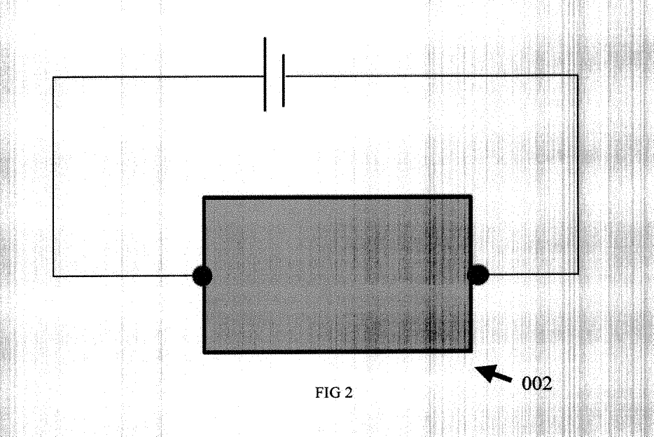

2. In the spirit of i1-Scale patent application Ser. No. 14/806584, claim [0011], the said term tamper proof is enhanced by the seal identified in FIG. 2 of this continuation in parts.

3. In the spirit of the i1-Scale patent application Ser. No. 14/806584, the detachable sensor element and sensor 001 (above), 005 (above), signal conditioner 023 (see patent application id above)—and circuitry can be constructed into a trailer, tractor, or tractor trailer at the factory; or the said sensors and circuitry can be retro fit on to a trailer, tractor, or tractor trailer.
Mounting the gages to the trailer, tractor or tractor trailer can be in the form where a set of gages are embedded into the center of the mid-plane of a thin fiber matrix composite plate; where the said sensor can be wireless or wired, where the said thin plate surfaces can be bonded to the component surface members of a trailer, tractor, or tractor trailer member, substantially; where the exposed surface of the un-bonded thin plate can be covered with protective coatings or other shrouding; where the sensor plates may be recertified or replaced during the service life of the trailer, tractor or tractor trailer.
